(19) United States
(12) Patent Application Publication
(10) Pub. No.: US 2014/0138148 A1
(43) Pub. Date: May 22, 2014

(54) FEED THROUGH

(71) Applicant: ELECTRONICS AND TELECOMMUNICATIONS RESEARCH INSTITUTE, Daejeon (KR)

(72) Inventor: Jong Jin LEE, Gwangju (KR)

(73) Assignee: Electronics and Telecommunications Research Institute, Daejeon (KR)

(21) Appl. No.: 13/842,537

(22) Filed: Mar. 15, 2013

(30) Foreign Application Priority Data
Nov. 16, 2012 (KR) 10-2012-0130546

(51) Int. Cl. H02G 3/22

(52) U.S. Cl. CPC H02G 3/22
USPC 174/650

(57) ABSTRACT

Provided is a feed through. The feed through comprises: an optical device; a housing surrounding the optical device and having a first hole; a solder coupled into the first hole and having a plurality of second holes, each smaller than the first hole; and lead frames leading from the inside of the housing to the outside through the second holes and having a more reduced line width at the inside of the second holes than the outside thereof.

### CROSS-REFERENCE TO RELATED APPLICATIONS

This U.S. non-provisional patent application claims priority under 35 U.S.C. §119 of Korean Patent Application No. 10-2012-0130546, filed on Nov. 16, 2012, the entire contents of which are hereby incorporated by reference.

### BACKGROUND OF THE INVENTION

The present invention disclosed herein relates to a signal transmission line, and more particularly, to a feed through.

An optical transceiver comprises a laser diode or a photodiode. The laser diode or the photodiode may have different operating characteristics depending on a surrounding temperature or moisture change. Due to this, the optical transceiver mounted on a feed through is commercialized. The feed through may minimize signal loss and noise occurrence with internal and external impedance matching

A typical feed through comprises a lead pin having a coaxial waveguide structure. The lead pin may be connected to a flexible printed circuit board (FPCB) at the outside of the feed through. The FPCB may have a signal wire of a coplanar waveguide (CPW) structure. When the signal wire and the lead pin are bonded to each other, mode transition may occur at the bonding part. The mode transition may increase the reflection loss of an optical transceiver.

### SUMMARY OF THE INVENTION

The present invention provides a feed through for preventing or minimizing the reflection loss of an optical device.

Embodiments of the inventive concept provide a feed through comprising: an optical device; a housing surrounding the optical device and having a first hole; a solder coupled into the first hole and having a plurality of second holes, each smaller than the first hole; and lead frames leading from the inside of the housing to the outside through the second holes and having a more reduced line width at the inside of the second holes than the outside thereof.

The lead frames may comprise a signal pin and a plurality of ground pins at both sides of the signal pin.

The signal pin and the ground pins may comprise metal plate wires.

A line width of each of the metallic plate wires may be vertically uniform at the outside and inside of the second holes and may be laterally reduced.

The signal pin may extend straight in the housing.

The plurality of ground wires may be bent toward the direction of the signal pin in the housing.

The feed through may further comprise a printed circuit substrate between the optical device and the lead frames.

The housing may comprise metal.

The solder may comprise a lower solder and an upper solder coupled to the lower solder.

The lower solder and the upper solder may comprise glass.

The feed through may further comprise a pin mount and a dielectric block.

The dielectric block may comprise glass or ceramic.

When the dielectric block is formed of the same material as the lower solder and the upper solder, it may be thicker than the lower solder or the upper solder.

### BRIEF DESCRIPTION OF THE DRAWINGS

The accompanying drawings are comprised to provide a further understanding of the present invention, and are incorporated in and constitute a part of this specification. The drawings illustrate exemplary embodiments of the inventive concept and, together with the description, serve to explain principles of the present invention. In the drawings:

FIG. 1 is a plan view illustrating a feed through according to an embodiment of the inventive concept;

FIG. 2 is a sectional view of FIG. 1;

FIG. 3 is an exploded perspective view of FIG. 1;

FIG. 4 is a perspective view of a solder ball of FIG. 3; and

FIG. 5 is a plan view of lead frames of FIG. 3.

### DETAILED DESCRIPTION OF PREFERRED EMBODIMENTS

Preferred embodiments of the inventive concept will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

The meaning of “include,” “comprise,” “including,” or “comprising,” specifies a property, a region, a fixed number, a step, a process, an element and/or a component but does not exclude other properties, regions, fixed numbers, steps, processes, elements and/or components. An embodiment described and exemplified herein includes a complementary embodiment thereof.

Hereinafter, it will be described about an exemplary embodiment of the inventive concept in conjunction with the accompanying drawings.

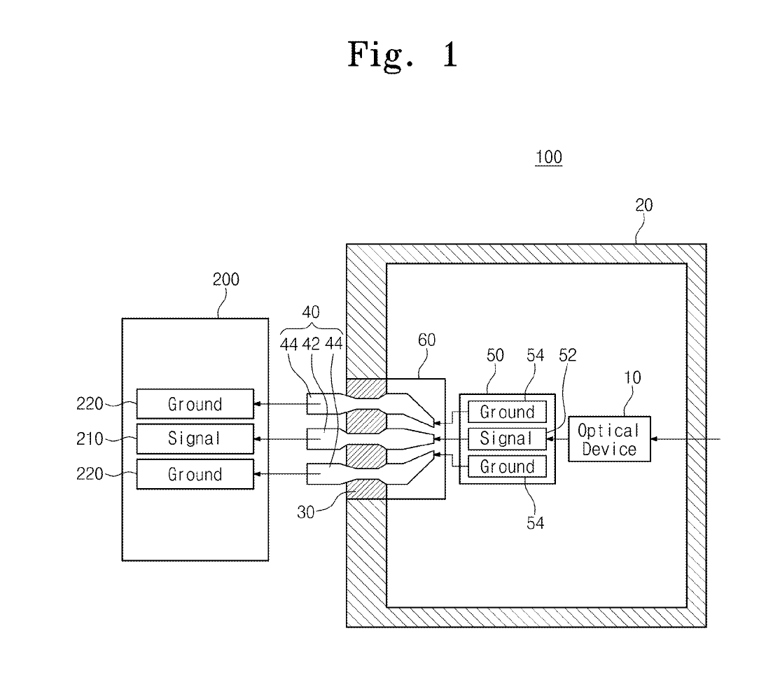

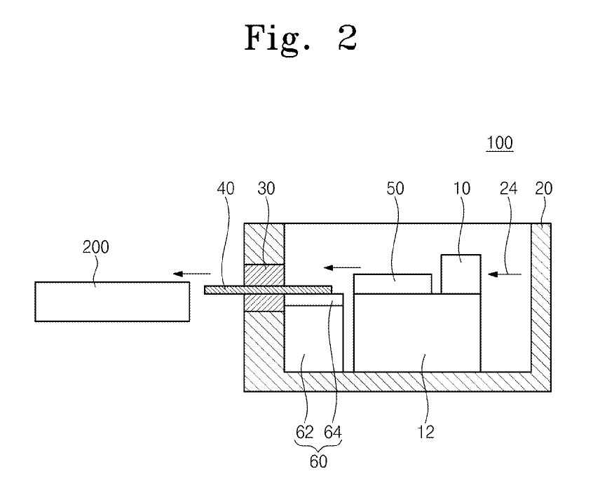

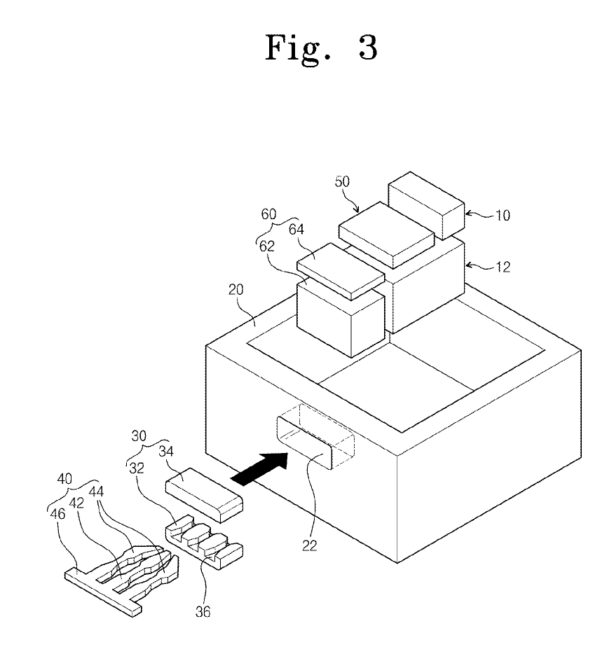

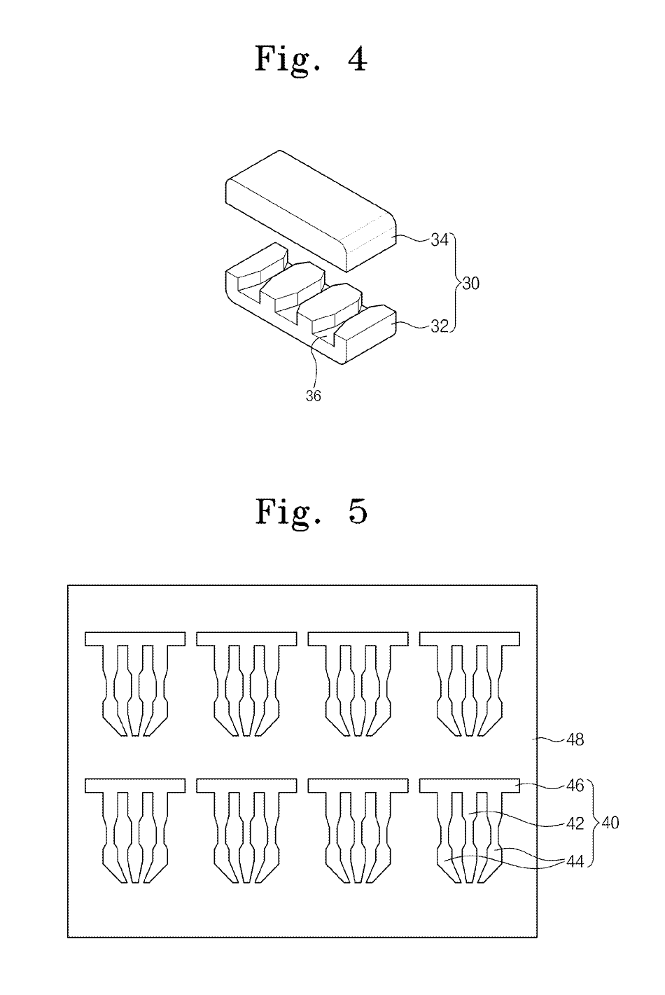

FIG. 1 is a plan view illustrating a feed through 100 according to an embodiment of the inventive concept. FIG. 2 is a sectional view of FIG. 1. FIG. 3 is an exploded perspective view of FIG. 1. FIG. 4 is a perspective view of a solder ball 30 of FIG. 3. FIG. 5 is a plan view of lead frames 40 of FIG. 3.

Referring to FIGS. 1 to 5, the through feed 100 may comprise an optical device 10, a housing 20, a solder 30, lead frames 40, an internal printed circuit substrate 50, and an internal support 60. The optical device 10 may comprise an optical transceiver. The optical transceiver may be a photodiode. The photodiode may generate an optical signal through a supply voltage from the outside. Additionally, the photodiode may receive an optical signal. The optical device 10 and the internal printed circuit substrate 50 may be disposed on a device mount 12 in the housing 20.

The housing 20 may receive the optical device 10, the internal printed circuit substrate 50, and the internal support 60. The housing 20 may have a basket shape having sides and a bottom, or a cube box shape. Although not shown in the drawings, the box-shaped housing 20 may comprise a cover covering the optical device 10, the internal printed circuit substrate 50, and the internal support 60. The housing 20 may have a first hole 22. The solder 30 and the lead frames may penetrate the first hole 22.

The solder 30 and the lead frames 40 may seal the first hole 22. The solder 30 may comprise a dielectric such as glass. The lead frames 40 may lead into second holes 36. The solder 30 may comprise a lower solder 32 and an upper solder 34. The second holes 36 may be provided by combining the lower solder 32 and the upper solder 34. The lower holder 32 and the upper solder 34 are coupled and then fused for sealing at high temperature. At this point, the solder 30 and the lead frames 40 may have air tightness.

The lead frames 40 may be directly connected to the external printed circuit substrate 200 and an internal printed circuit substrate 50, or may be connected to them through a bonding wire (not shown). The external printed circuit substrate 200 and the internal printed circuit substrate 50 may have a first signal wire 210 and a second signal wire 52, respectively. Additionally, the external printed circuit substrate 200 and the internal printed circuit substrate 50 may have first ground wires 220 and second ground wires 53, respectively. Although not shown, at least one of the first ground wires 220 and the second ground wires 54 may be electrically connected to the housing 20.

The lead frames 40 may comprise a signal pin 42 and ground pins 44. The signal pin 42 may be connected to the first signal wire and the second signal wire at the both sides. The signal pin 42 may extend straight in the housing. The ground pins 44 may be connected to the first ground wires 220 and the second ground wires 54. The ground pins 44 may be disposed at both sides of the signal pin 42. The ground pins 44 may be bent in the housing 20, converging toward the direction of the signal pin 42. The signal pin 42 and the ground pins 44 may comprise planar type metal plate wires. The line widths of the signal pin 24 and the ground pins 44 may be determined by a permittivity difference of the solder 30 and air. The solder 30 may have a higher permittivity than air. For example, the signal pin 42 and the ground pins 44 may have reduced line widths in the second hole 36. The reason is because a signal interference between the signal pin 42 and the ground pins 44 in the solder 30 formed of glass may be minimized Additionally, an impedance of a high frequency signal applied through the signal pin 42 may be matched.

The signal pin 42 and the ground pins 44 may be vertically uniform at the outsides and insides of the second holes 36 and may be laterally reduced. That is, an interval between the signal pin 42 and the ground pins 44 may be increased more in the solder 30 than at the inside or the outside. The lead frames 40 may be fixed at the inside of the housing 20 by the internal support 60.

The internal support 60 may comprise a pin mount 62 and a dielectric block 64. The pin mount 62 may be disposed at the bottom of the housing 20. The dielectric block 64 may be disposed between the pin mount 62 and the lead frames 40. The pin mount 62 may be a ground plane. The dielectric block 64 may comprise glass or ceramic. For example, if the dielectric block 64 is made of glass, it may be thicker than the lower solder 32 or the upper solder 34. Herein, the thicknesses of the lower solder 32 and the upper solder 34 may be defined from the second holes 36 to the edge of the solder 30. The dielectric block 64 may minimize an interference between the lead frames 40 and the pin mount 62. The solder 30 and the dielectric block 64 may match an impedance of a high frequency signal at the lead frame 40 of the inside and outside of the housing 20.

Accordingly, the feed through 100 according to an embodiment of the inventive concept may minimize or prevent the reflection loss due to impedance mismatching of the signal pin 42. The lead frames 40 may comprise a lead coupling pin 46 connected to the signal pin 42 and the ground pins 44. The lead coupling pin 46 may be cut after the lead frames 40 are coupled to the solder 30. A mother board 48 may fix a plurality of lead frames 40. The lead frames 40 may be separately and easily detached from the mother board 48. The mother board 48 and the lead frames 40 may be formed of a metallic material such as an aluminum alloy. Additionally, the lead frames 40 may be easily manufactured. The lead frames 40 may be patterned using a laser beam or an etchant.

According to embodiments of the inventive concept, a feed through comprises an optical device, a hosing, a solder, and lead frames. The housing surrounds the optical device and has a first hole that leads the feed through in one direction. The feed through and the solder may seal the first hole. The lead frames may comprise a signal pin and a plurality of ground pins at the both sides of the signal pin. The signal pin and the ground pins may have a line width which is more reduced in the inside of the first hole than the outside. The lead frames having a reduced line width in the solder may match an impedance of a high frequency signal.

Accordingly, the feed through according to an embodiment of the inventive concept may minimize or prevent the reflection loss due to impedance mismatching.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A feed through comprising:
an optical device;
a housing surrounding the optical device and having a first hole;
a solder coupled into the first hole and having a plurality of second holes, the plurality of second holes is smaller than the first hole; and
lead frames leading from the inside of the housing to the outside through the second holes and having a more reduced line width at the inside of the second holes than the outside thereof.

2. The feed through according to claim 1, wherein the lead frames comprise a signal pin and a plurality of ground pins at both sides of the signal pin.

3. The feed through according to claim 2, wherein the signal pin and the ground pins comprise metal plate wires.

4. The feed through according to claim 3, wherein a line width of each of the metallic plate wires is vertically uniform at the outside and inside of the second holes and is laterally reduced.

5. The feed through according to claim 2, wherein the signal pin extends straight in the housing.

6. The feed through according to claim 5, wherein the plurality of ground wires are bent toward the direction of the signal pin in the housing.

7. The feed through according to claim 1, further comprising a printed circuit substrate between the optical device and the lead frames.

8. The feed through according to claim 1, wherein the housing comprises metal.

9. The feed through according to claim 1, wherein the solder comprises a lower solder and an upper solder coupled to the lower solder.

10. The feed through according to claim 9, wherein the lower solder and the upper solder comprise glass.

11. The feed through according to claim 9, further comprising a pin mount and a dielectric block.

12. The feed through according to claim 11, wherein the dielectric block comprises glass or ceramic.

13. The feed through according to claim 12, wherein when the dielectric block is formed of the same material as the lower solder and the upper solder, it is thicker than the lower solder or the upper solder.
